(19) United States
(12) Patent Application Publication
(10) Pub. No.: US 2008/0272206 A1
(43) Pub. Date: Nov. 6, 2008

(54) DEVICE FOR DISPENSING LIQUIDS IN THE SHOWER

(76) Inventor: Martin A. Barrett, Fort Lauderdale, FL (US)

Correspondence Address: FLEIT GIBBONS GUTMAN BONGINI & BIANCO P.L., ONE BOCA COMMERCE CENTER, 551 NORTHWEST 77TH STREET, SUITE 111, BOCA RATON, FL, 33487, US

(21) Appl. No.: 11/743,918

(22) Filed: May 3, 2007

(51) Int. Cl. B05B 15/06

(52) U.S. Cl. 239/282

(57) ABSTRACT

A device for applying a liquid to a body includes a reservoir for holding a liquid and a liquid-dispensing nozzle coupled to the reservoir, the nozzle operable to move alternately upward and downward and spray a stream of the liquid in a direction away from the device and in a vertical pattern.

### FIELD OF THE INVENTION

The present invention relates generally to dispensing shower liquids, such as soap and shampoo, and more particularly relates to dispensing and automatically applying shower liquids to a person's body.

### BACKGROUND OF THE INVENTION

Showering is a daily activity that most people take for granted. However, for some, it is a difficult task. Specifically, those with certain physical impairments find it quite difficult to reach all areas of their bodies. Applying soap to unreachable areas becomes a daunting task and often results in reduced frequency of cleaning, which can result in negative health and social issues.

One relatively recent option for applying soap to hard-to-reach areas is the use of a shower “gel”. Gels are liquid soaps that have a consistency similar to dishwashing liquid. Shower gels can be dripped out of the container and onto hard-to-reach areas, such as one's back or feet. However, manually holding a bottle of shower gel and targeting specific areas requires attention and is tedious.

Therefore a need exists to overcome the problems with the prior art as discussed above.

### SUMMARY OF THE INVENTION

Briefly, in accordance with the present invention, disclosed is a device for applying a liquid to a body, where the device includes a reservoir for holding a liquid and a liquid-dispensing nozzle coupled to the reservoir, the nozzle operable to move alternately upward and downward and spray a stream of the liquid in a direction away from the device and in a vertical pattern.

In accordance with another feature, an embodiment of the present invention includes an attachment means for attaching the device to a wall.

In accordance with a further feature of the present invention, the attachment means is variable in height.

In accordance with a further feature, the present invention includes an attachment bracket having a plurality of height levels, wherein the device is attachable to the attachment bracket at least two of the plurality of height levels.

In accordance with yet another feature, the present invention includes a pump operable to cause the liquid to move from the reservoir to the nozzle and a timer operable to cause the motor to operate for a pre-determined amount of time.

In accordance with one additional feature, the present invention includes a stream width adjuster.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a side view of a user in a shower stall with a liquid dispenser attached to a wall of the shower in accordance with the present invention.

FIG. 2 is a front perspective view of a liquid dispenser in accordance with the present invention.

FIG. 3 is a side view illustrating an adjustable spray angle of a liquid dispenser in accordance with an embodiment of the present invention.

FIG. 4 is a top view illustrating an adjustable stream width of a liquid dispenser in accordance with an embodiment of the present invention.

FIG. 5 is a perspective view of a liquid dispenser with motion detector and a moisture detector in accordance with the present invention.

FIG. 6 is a perspective view of a liquid dispenser with suction devices in accordance with the present invention.

FIG. 7 is a perspective view of a liquid dispenser with hook attachment devices and an attachment rack in accordance with the present invention.

FIG. 8 is a process flow diagram of a method of applying liquid to a user in a shower by manual user initiation in accordance with the present invention.

FIG. 9 is a process flow diagram of a method of applying liquid to a user in a shower by automatic user detection in accordance with the present invention.

FIG. 10 is a process flow diagram of a method of applying liquid to a user in a shower by automatic user detection and automatic moisture detection in accordance with the present invention.

FIG. 11 is a side view of a motorized nozzle that moves in upward and downward directions in accordance with the present invention.

FIG. 12 is a schematic diagram of an automatic liquid dispenser according to an embodiment of the present invention.

FIG. 13 is a side view of a stream width adjuster according to an embodiment of the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The present invention, according to an embodiment, overcomes problems with the prior art by providing a dispenser that automatically applies a cleansing liquid, such as liquid soap or any other liquid cleaning material to a human body by spraying the material directly on a user in the shower. The inventive device obviates a need for the user to manually apply cleaning solution to each of his/her body parts.

Described now is an exemplary liquid applicator device for use with embodiments of the present invention.

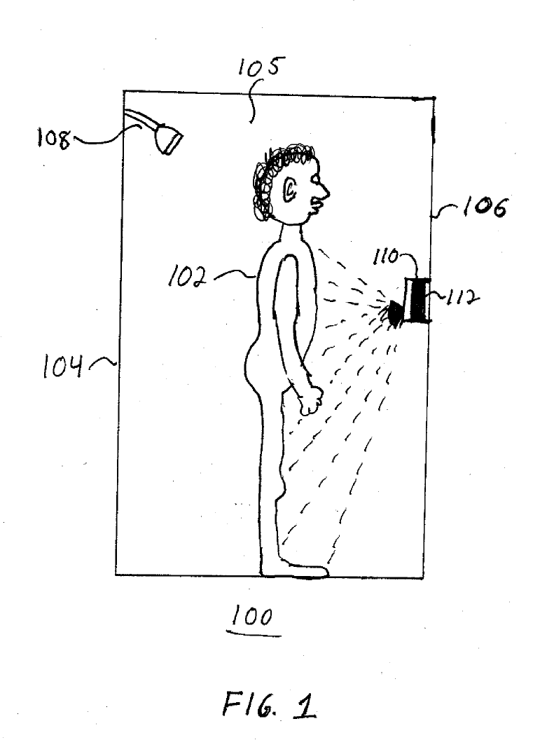

FIG. 1 shows a typical and well-known shower stall 100. A shower stall 100, typically has three walls 104, 105, and 106 and a door (not shown) and is the place where a user 102 enters in order to wash himself/herself with a stream of water provided by a shower “head” 108.

While in the shower 100, a user 102 typically uses a type of soap. Soap is a surfactant used in conjunction with water for washing and cleaning. Traditionally, soap has been made available in a solid molded form, termed “bars” due to its historic and most typical shape. Relatively recently, however, the use of liquid soap, or “shower gel,” has become widespread. Applied to a soiled surface, soapy water effectively holds particles in suspension and allows it to be rinsed off with clean water.

Soap can be easily applied to a subject in a shower or other places through use of embodiments of the present invention. FIG. 1 shows one embodiment of the present invention 110 attached to a wall 106 of the shower 100. As will be explained in detail below and shown in the accompanying figures, the present invention 110 is operable to emit a stream of liquid soap 112, which makes contact with a user 102 in the shower 100. Through use of the present invention, one no longer has to perform the task of bending over to get soap to their lower extremities or awkwardly reach behind their back to apply soap. This is especially advantageous to those with physical impairments, to whom bending over and/or reaching places on their backs is either difficult or impossible.

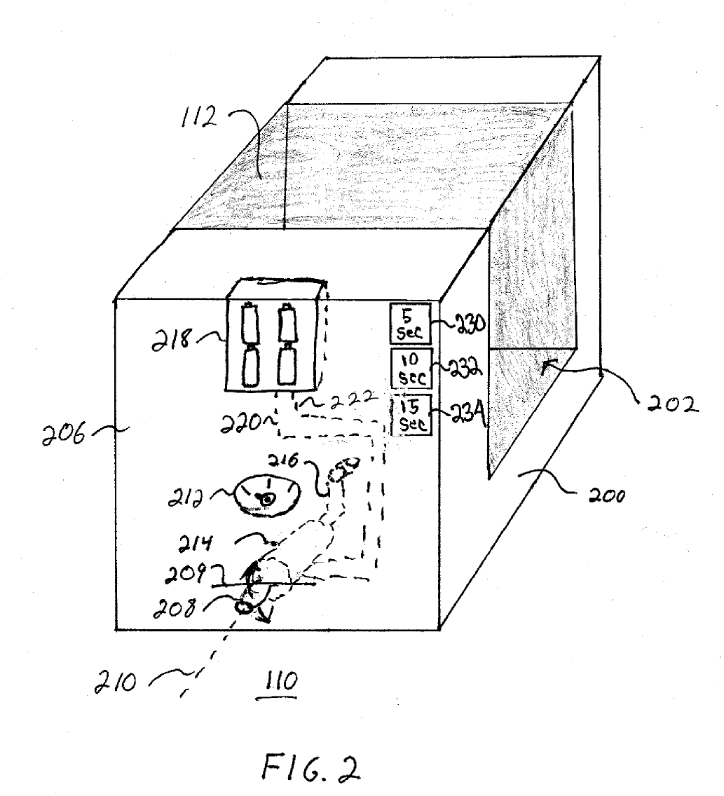

A more detailed view of the dispenser 110 is shown in FIG. 2. FIG. 2 shows a front perspective view of one embodiment of the dispenser 110. In this embodiment, the dispenser 110 has a main body 200. The main body 200 has a reservoir section 202 for storing an amount of liquid soap (not shown). The reservoir section 202, in one embodiment, is a containment area in which soap can be poured into. In other embodiments, the reservoir 202 is provided with a coupling means for accepting a separate soap container that fits within the reservoir section 202. For instance, the reservoir section 202 can have a threaded fitting or other type of quick disconnect fitting so that a soap bottle can be screwed into it. In other embodiments, a customized soap container that fits into the reservoir can be sold separately. Users can purchase the customized soap container anytime they require soap for the device 110.

It is envisioned, however, that the present invention can be used for liquids other than soap and is, therefore, not so limited. For instance, the device 110 can be filled with shampoo, lotions, or any other similar liquid. The invention is also not limited to any size or shape of reservoir 202. The particular reservoir 202 shown in FIG. 2 is rectangular for ease of discussion.

On a front face 206 of the dispenser 110 is a nozzle 208. The nozzle 208 is provided for the purpose of directing a stream 210 of liquid 112 from the reservoir 202 in a particular direction away from the dispenser 110. When a user 102 is in front of the nozzle 208, the emitted liquid 112 will be applied to the user's body. In one embodiment of the present invention, the nozzle 208 pivots at a horizontal pivot point 209 and moves in alternating upward and downward directions, as indicated by the up arrow and down arrow in FIG. 2. The moving nozzle 208 allows the soap 112 to be applied to multiple areas of the user's body.

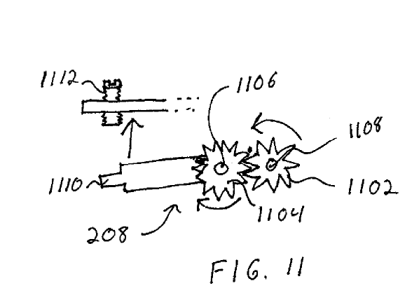

FIG. 11 shows how the nozzle 208 can be moved up and down, in accordance with one embodiment of the present invention. In this embodiment, the nozzle 208 has a pivot point 1106 and gear 1104 centered on the pivot point 1106. The pivot point 1106 is stationary and can be a type of a shaft. A second gear 1102 is attached to an electric motor (not shown). The motor used is able to cause the gear 1102 to rotate in two directions along a second pivot point 1108. When the motor causes the second gear 1102 to rotate in a first direction, which is indicated by the arrow in FIG. 11 around the second gear 1102, the second gear 1102 makes contact with the first gear 1104 and causes the first gear 1104 to rotate in the directions shown by the arrow around the first gear 1104. Because the first gear 1104 pivots at pivot point 1106, the end 1110 of the nozzle 208 moves in an upward direction, shown by the upward arrow. Liquid being emitted from the nozzle 208 will be applied to a user in the shower in a vertical pattern along the length of the user's body. Conversely, if the second gear 1102 is rotated in a direction opposite the arrow, the nozzle 208 will be moved in a downward direction.

In another embodiment, the limits of movement of the nozzle 208 can be adjusted mechanically or limited so as to accommodate users of varying heights or to allow users to prevent soap 112 from being applied to certain areas of their bodies. For instance, a taller person may wish for the nozzle to eject soap 112 up to a greater height than would a shorter person.

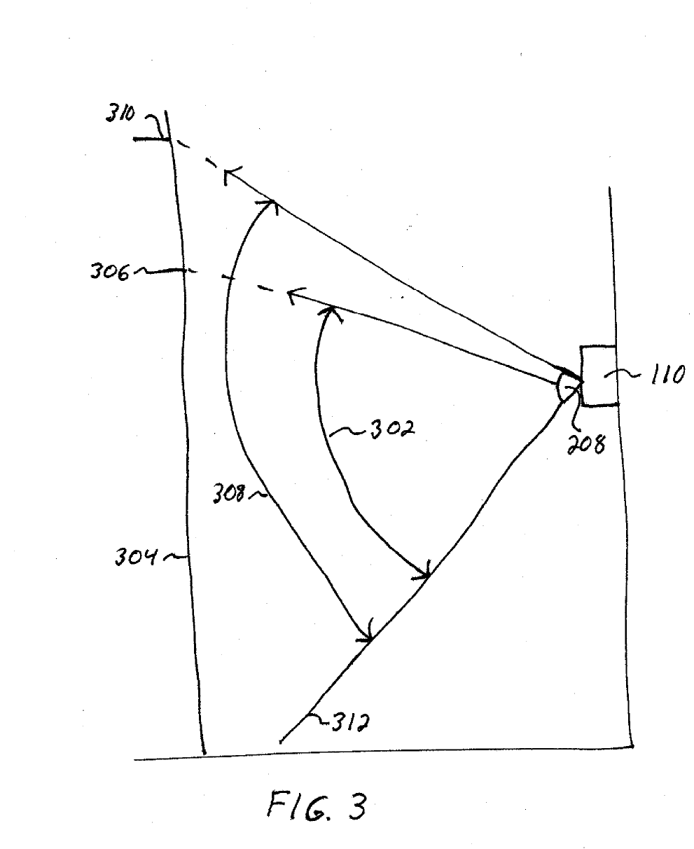

As shown in FIG. 3, the movement of the nozzle 208 can have a first setting with a movement range 302. The maximum height is projected onto a line 304 at point 306. At a second setting, the nozzle 208 can have an increased movement range 308. At this increased range 308, the nozzle ejects soap to a height 310, which is greater than the maximum height 306 reached by the nozzle 208 when set at movement range 302. In this particular example, the lower limit of the spray 312 was the same for both settings 302 and 308. This is because regardless of how tall one is, their feet will still be on the floor. One type of adjustment is a set screw 1112, shown in FIG. 11 that limits the upward movement range of the nozzle 208. A similar screw can be placed below the nozzle to limit the downward movement as well. It is important to note that other types of adjustments and mechanical limiters may be used and are within the true spirit and scope of the invention. However, it is envisioned that both the maximum and minimum height limits could be adjusted with embodiments of the present invention.

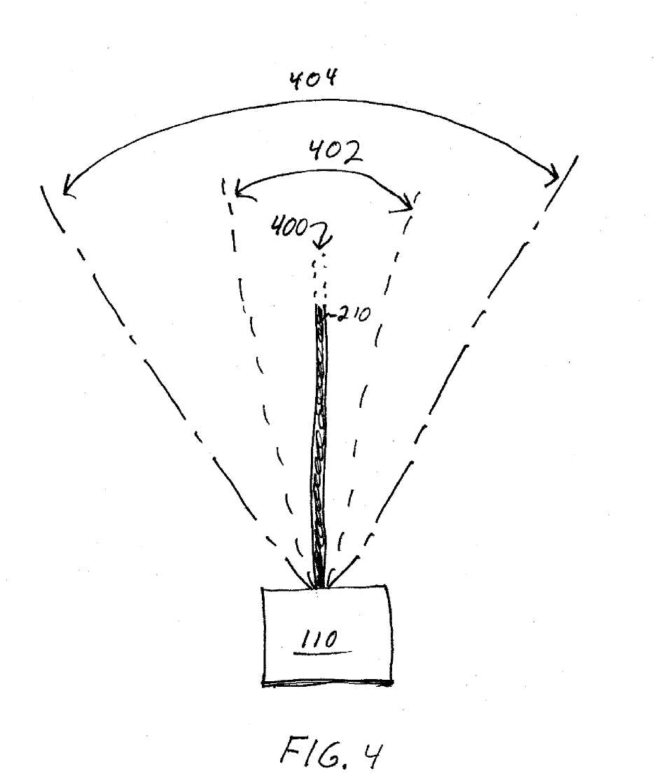

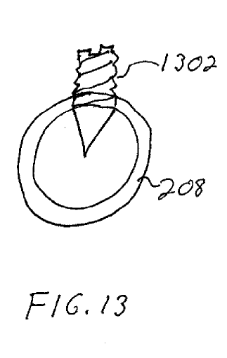

In yet another embodiment, as shown in FIG. 4, the nozzle 208 is adjustable so that the width of the spray 210 can be varied. For instance, in one setting 400, the spray 210 may be substantially a straight line of soap, similar to the spray from a squirt gun. At another setting 402, the spray may fan out and be several inches wide at the point of contact with the user. In yet another setting 404, the spray can be even wider yet. The width of the spray is varied with a stream width adjuster 1302, as shown in FIG. 13, that can be introduced into a stream of liquid and cause the flow of liquid to be interrupted and dispersed.

Referring now back to FIG. 2, in one embodiment of the present invention, the dispenser 110 is provided with a timer module 212. The timer module 212 allows a user 102 to set the amount of time the dispenser 110 will spray soap on the user 102. For instance, the user 102 may set the timer module for 5 seconds. In this case, the dispenser 110 will spray soap for only 5 seconds and then stop. Any other increments are possible and are within the scope of the invention. In one embodiment, the dispenser 110 is provided with buttons 230, 232, 234 instead of, or in addition to the dial-type timer module 212. The buttons 230, 232, 234 allow the user to select a time increment for which the dispenser will spray liquid. In the embodiment shown in FIG. 2, each button 230, 232, 234 are labeled with a time increment so that the user knows which increment he/she is choosing. For some users, depressing on of the buttons 230, 232, 234 to select a time increment may be easier than turning the dial 212. The buttons 230, 232, 234 might cater more so to the disabled and elderly. Use of buttons 230, 232, 234 might also create more permutations for dispensing the soap at the specific need of the user (single users who want different “shots” of soap, or multiple users of the same shower may want soap dispensed at different durations).

The mechanism for causing the soap to move from the reservoir 202 out through the nozzle 208 can be any appropriate pumping or liquid displacement device. Pumping devices are well known in the art and are available in a large variety of types and sizes. In one embodiment, power is provided to the pump 214, which draws the liquid from the reservoir 202 through a liquid passageway 216. Although the present invention is not limited to any particular type of pumping device 214, in a preferred embodiment, the pumping device 214 chosen will have enough force to eject the liquid through the nozzle 208 and onto a user 102 in the shower.

Power can be provided to the pump 214 by any appropriate power source. Because the device is intended for use in the shower, in one embodiment, the dispenser 110 is provided power by a low-voltage DC power source 218, such as a set of batteries. The batteries provide power to the pump 214 through conductive wires 220 and 222. In one embodiment, an extra motor (not shown) may be provided that works to drive the pump 214.

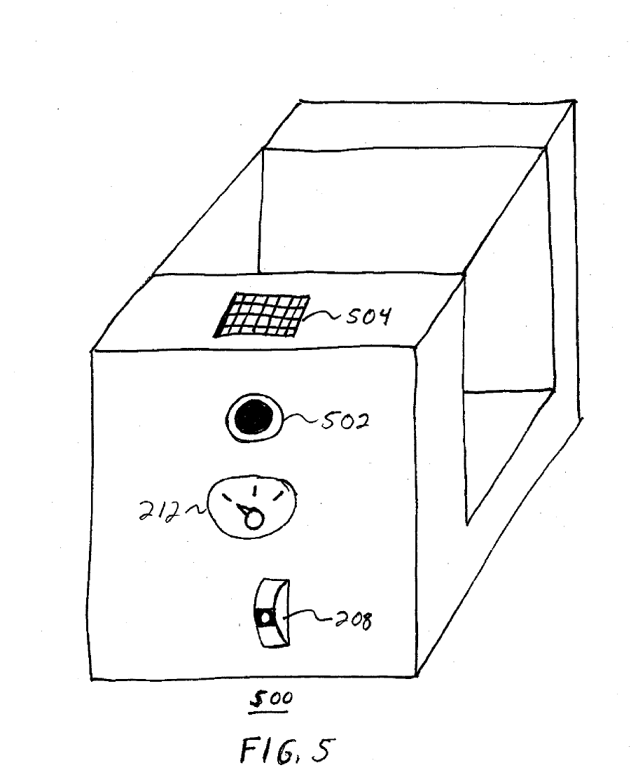

FIG. 5 shows yet another embodiment of the present invention. The embodiment of FIG. 5 provides a more automated process for the present invention to apply soap to a user. The dispenser 500, in this embodiment, is equipped with a presence detector 502, such as an infra red motion detector. Motion detectors are well known in the art. The presence detector 502 senses when a user is in the shower and, in particular, in close proximity to the dispenser 500. Once the motion detector 502 senses a user, it triggers the device to eject soap from nozzle 208. However, in some cases, a user may enter a shower for reasons other than to wash themselves. For instance, a user may enter a shower stall in order to collect used wash cloths or to replace a bottle of shampoo. In these circumstances, a spray of shower gel from the dispensing device 500 would most likely be unwelcome. For this situation, the dispensing device 500 can be equipped with a water or moisture detector 504. The moisture detector 504 only allows the device 500 to operate if water is detected, such as when the shower is in use. Moisture detectors are available from the Digi-Key Corporation of Minnesota, Thief River Falls. Once water and a user are detected, the device 500 operates as described above. In particular, the timer 212 can still dictate the length of time that the device will spray soap from the nozzle 208. The dispenser 500 can be programmed so that once moisture and a user is detected, and the dispenser 500 completes one spray cycle, the dispenser 500 will not spray again for a predetermined length of time. This avoids a situation where a user would be inadvertently sprayed a second time in the same shower session.

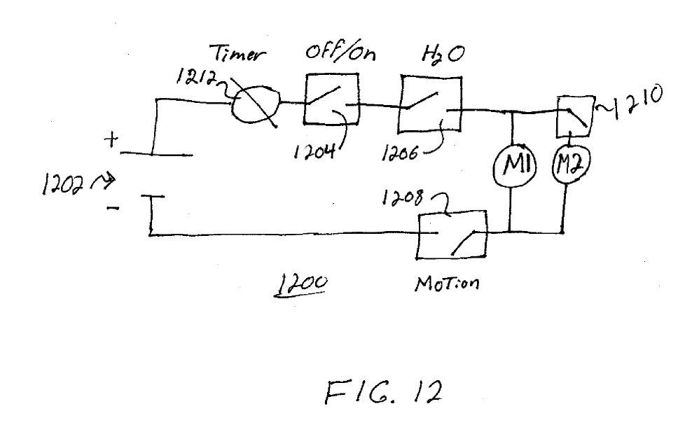

FIG. 12 shows one embodiment of the circuit 1200 of one embodiment of the present invention. The circuit 1200 derives power from a power source 1202. The circuit 1200 has a main off and on switch 1204. If the main switch 1204 is in the off position, the invention will not receive power from the power source 1202 and will not function. The circuit 1200 also has a moisture sensor switch 1206 and a motion sensing switch 1208. If either of these switches is open, the circuit 1200 will not receive power from the power source 1202 and the circuit will not function. Again, the moisture sensor 1206 and the motion sensor 1208 are each optional features and are not necessary for the function of the present invention.

When the on/off switch 1206, the moisture detector 1206, and the motion detector 1208 are all in the on position, the pump motor M1 is supplied power and begins pumping liquid. A second motor M2 can also be supplied power through switch 1210. When motor M2 is supplied with power, it causes the nozzle 208 to move in an upward and downward motion. In addition, a timer module 1212 is provided in the circuit. The timer module opens the circuit 400 after a specified amount of time.

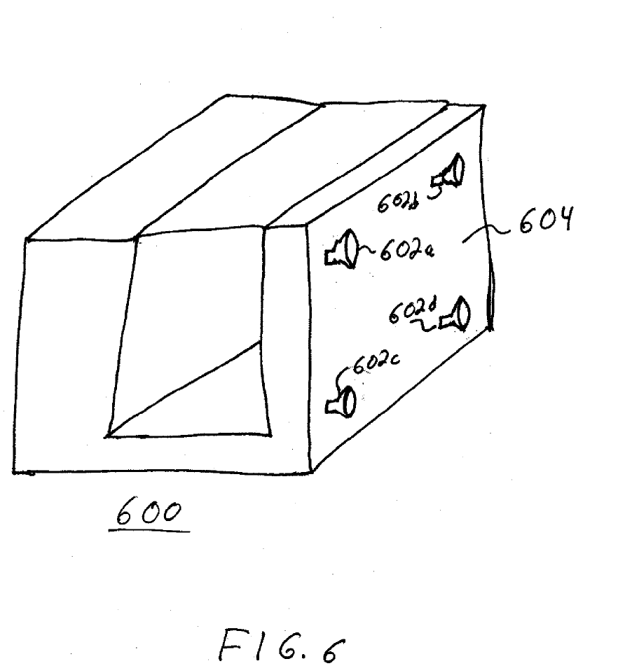

The present invention provides various means for attaching the dispenser to a shower wall, such as wall 106 in FIG. 1. In one embodiment, shown in FIG. 6, the dispenser 600 is provided with suction devices 602a-d. Once the side 604 of the dispenser 600 with the suction devices 602a-d is pressed against a relatively smooth surface, the suction devices 602a-d allow the dispenser to adhere to the shower wall. Suction devices are advantageous in that they are not limited to any specific location or height within the shower stall. They allow the dispenser 600 to be placed in any suitable spot that allows the dispenser 600 to function for its intended purpose or even for out-of-the-way storage when the dispenser 600 is not currently needed.

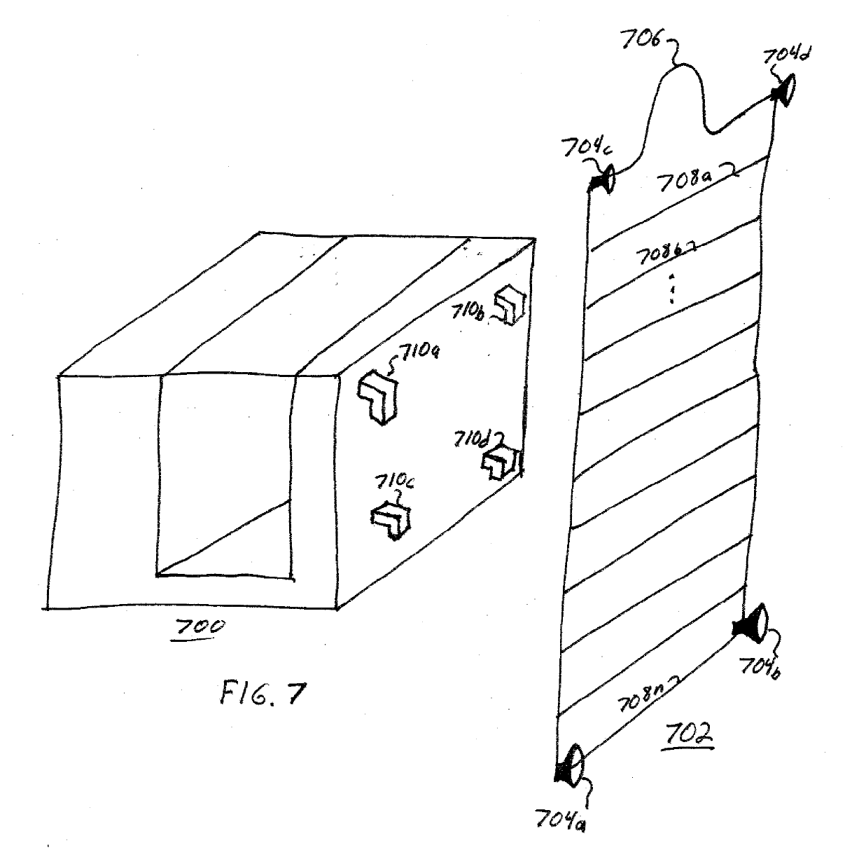

In yet another embodiment of the present invention, a rack 702, as shown in FIG. 7, can be used to secure the dispenser 700 to a wall. The rack 702 is intended to be attached to a shower or other type of wall either through suction devices 704a-d or with a loop 706 that fits over the neck of a shower head. The rack 702, in one embodiment, has a plurality of rows 708a-n on which the dispenser 700 can be hung. In this embodiment, the dispenser 700 is provided with a set of hooks 710a-d that grab onto a set of the rows 708a-n of the rack 702. The height of the dispenser 700 can be adjusted by simply placing the hooks 710a-d on any one of the height levels, i.e. a different set of rows 708a-n, of the rack 702.

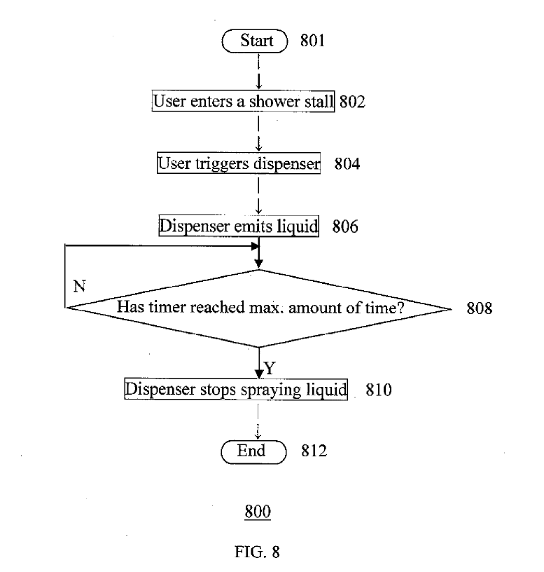

FIG. 8 shows a process 800 of applying soap to a user through use of the present invention. The process begins at step 801 and moves directly to step 802, where a user enters a shower stall. In step 804, the user triggers the inventive dispenser by pushing a button, or through any of the means previously described. Once the dispenser is triggered, the dispenser begins emitting shower gel or any other liquid material through its nozzle onto the user in step 806. In step 808 a check is performed to determine whether a timer has reached a maximum amount of time for spraying the liquid onto the user. Once the maximum time has been reached, the dispenser stops spraying in step 810 and the process ends at step 812.

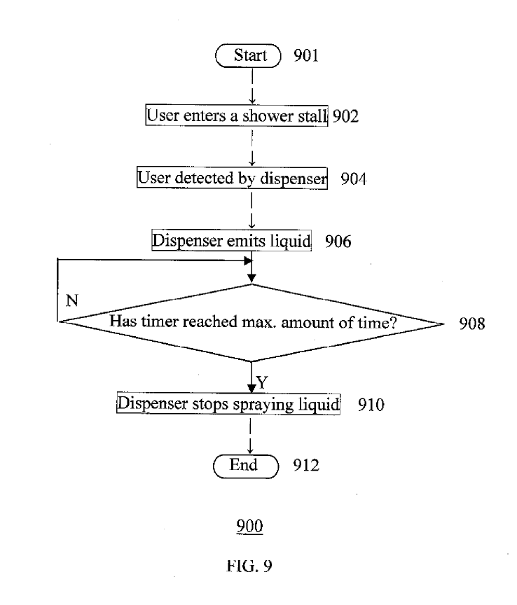

FIG. 9 shows a second embodiment of a process of applying soap to a user through use of the present invention. The process 900 begins at step 901 and moves directly to step 902, where a user enters a shower stall. In step 904, a user is detected by the dispenser through use of a user detector, such as detector 502 in FIG. 5. Once the user is detected, the dispenser is triggered and begins emitting shower gel or any other liquid material through its nozzle onto the user in step 906. In step 908 a check is performed to determine whether the timer has reached a maximum amount of time. Once the maximum time has been reached, the dispenser stops spraying in step 910 and the process ends at step 912.

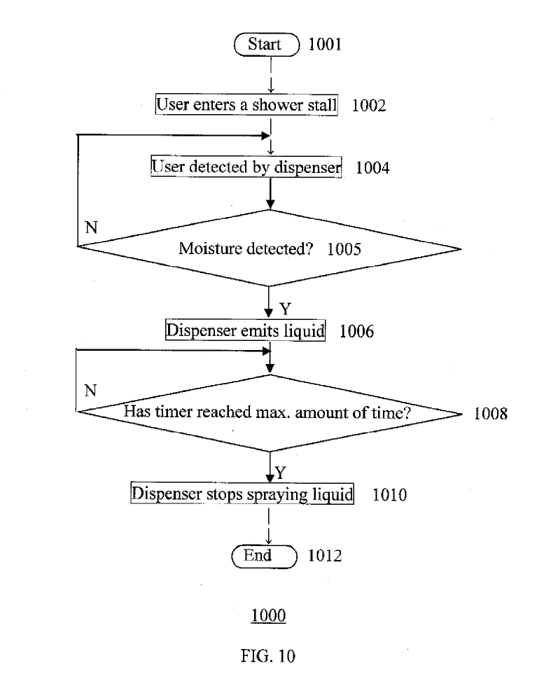

FIG. 10 shows yet another embodiment of a process of applying soap to a user through use of the present invention. The process 1000 begins at step 1001 and moves directly to step 1002, where a user enters a shower stall. In step 1004, a user is detected by the dispenser through use of a user detector, such as detector 502 in FIG. 5. Once the user is detected, a check is made, in step 1005, to determine whether a moisture detector has detected the presence of water in the shower. This detection can be performed by any suitable moisture detector, such as detector 504 shown in FIG. 5. If no moisture is detected, the process moves back up to step 1004. If moisture is detected, the process flow moves to step 1006 where the dispenser is triggered and begins emitting shower gel or any other liquid material through its nozzle onto the user. In step 1008 a check is performed to determine whether a timer dictating the amount of liquid spray time has reached a maximum amount of time. Once the maximum time has been reached, the dispenser stops spraying in step 1010 and the process ends at step 1012.

A dispenser has been described that is able to apply a liquid, such as shower gel, to a user's body by spraying the liquid from a nozzle that alternatively moves in an upward and downward motion. The dispenser is adjustable so that the liquid is applied only to desired portions of the user's body and for a length of time that is desired by the user. The invention advantageously obviates the need for a user to manually apply cleaning solution to the user's body.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

The terms “a” or “an”, as used herein, are defined as one, or more than one. The term “plurality”, as used herein, is defined as two, or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

What is claimed is:

1. A device for applying a liquid to a body, the device comprising:
a reservoir for holding a liquid; and
a liquid-dispensing nozzle coupled to the reservoir, the nozzle operable to move alternately upward and downward and spray a stream of the liquid in a direction away from the device and in a vertical pattern.

2. The device according to claim 1, further comprising:
attachment means for attaching the device to a wall.

3. The device according to claim 2, wherein:
the attachment means is variable in height.

4. The device according to claim 1, further comprising:
an attachment bracket having a plurality of height levels, wherein the device is attachable to the attachment bracket at least two of the plurality of height levels.

5. The device according to claim 1, further comprising:
a pump operable to cause the liquid to move from the reservoir to the nozzle; and
a timer operable to cause the motor to operate for a pre-determined amount of time.

6. The device according to claim 1, further comprising:
a stream width adjuster.

7. The device according to claim 1, wherein:
the nozzle pivots at a horizontal pivot point.

8. The device according to claim 1, further comprising:
a presence detector operable to detect the presence of a person in a shower.

9. The device according to claim 8, further comprising:
a moisture detector operable to detect the presence of water in the shower.

10. A device for applying a cleansing liquid to a human body, the device comprising:
a power source;
a reservoir for holding a cleansing liquid suitable for cleaning a human body;
a pump electrically coupled to the power source and physically coupled to the reservoir;
a liquid-dispensing nozzle coupled to the pump and the power source, the nozzle operable to move alternately upward and downward and spray a stream of the cleansing liquid onto a human body.

11. The device according to claim 10, further comprising:
a motor electrically coupled to the power source and the nozzle, the motor for causing the nozzle to move upward and downward.

12. The device according to claim 10, further comprising:
a switch electrically coupled to the power source, the switch operable to apply power to the pump.

13. The device according to claim 12, wherein the switch is one of:
a moisture detector operable to determine a presence of moisture on the dispenser;
a presence detector operable to determine a presence of a human body in proximity to the dispenser; and
a timer.

14. The device according to claim 10, further comprising:
a stream width adjuster operable to set a range of a spray angle of the dispenser.

15. The device according to claim 14, wherein the stream width adjuster includes at least one of:
a vertical range of nozzle movement; and
a width of spray exiting the nozzle.

16. The device according to claim 5, further comprising:
at least two buttons, wherein each button is used to set a predetermined time on the timer.
